(19) United States
(12) Patent Application Publication
(10) Pub. No.: US 2007/0070927 A1
(43) Pub. Date: Mar. 29, 2007

(54) RADIO COMMUNICATION APPARATUS WITH ANTENNAS, RADIO COMMUNICATION SYSTEM AND METHOD

(76) Inventors: Hiroki Shoki, Kawasaki-shi (JP); Yasuhiko Tanabe, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/428,694

(22) Filed: Jul. 5, 2006

(30) Foreign Application Priority Data
Sep. 29, 2005 (JP) 2005-283360

(51) Int. Cl. H04B 7/00

(52) U.S. Cl. 370/310

(57) ABSTRACT

A radio communication system includes a plurality of radio communication terminals each of which includes a plurality of first antennas, and a radio communication apparatus including a plurality of second antennas, an acquisition unit configured to acquire a plurality of channel response values between the first antennas and the second antennas, a setting unit configured to set, based on the channel response values, a plurality of MIMO parameters, and a transmission unit configured to perform multicast transmission to each of the radio communication terminals via the second antennas, based on the MIMO parameters. The multicast transmission is performed based on a multiple-input multiple-output (MIMO) transmission scheme. Each of the radio communication terminals further includes a receiving unit which receives data transmitted from the radio communication apparatus by the multicast transmission.

### CROSS-REFERENCE TO RELATED APPLICATIONS

This application is based upon and claims the benefit of priority from prior Japanese Patent Application No. 2005-283360, filed Sep. 29, 2005, the entire contents of which are incorporated herein by reference.

### BACKGROUND OF THE INVENTION

1. Field of the Invention

The present invention relates to a radio communication apparatus with a plurality of antennas, a radio communication system and a radio communication method for simultaneously transmitting (multicasting) the same signal to a plurality of radio communication terminals (STA) utilizing the multiple-input multiple-output (MIMO) transmission scheme.

2. Description of the Related Art

In recent years, application of the MIMO technique to cellular radio communication systems or wireless LAN systems has been proposed as means for realizing high-speed transmission using a limited frequency band. In the MIMO technique, a plurality of antennas are used for transmitting and receiving signals to detect a plurality of orthogonal channels in a multipath environment, and simultaneously transmit the same signal to the channels to thereby enhance the transmission speed. Systems utilizing the MIMO technique are expected to be used for high-speed radio transmission of, for example, audio-video data at home. Actually, the use of MIMO is now being discussed whether it is appropriate for a scheme for the next-generation LAN IEEE802.11n.

In MIMO, a plurality of antennas and radio units are needed for transmission and reception of data. In light of this, for instance, a scheme for interrupting the supply of power to unused antennas and radio units based on the state of communication or characteristic of data to be transmitted (see, for example, JP-A 2005-33284 (KOKAI)).

However, JP-A 2005-33284 (KOKAI) does not disclose how to perform communication in the multicast transmission scheme in which the same signal is simultaneously transmitted to a plurality of radio communication terminals, in order to acquire excellent characteristics in the terminals.

### BRIEF SUMMARY OF THE INVENTION

In accordance with an embodiment of the invention, there is provided a radio communication system comprising: a plurality of radio communication terminals each of which includes a plurality of first antennas; and a radio communication apparatus including: a plurality of second antennas; an acquisition unit configured to acquire a plurality of channel response values between the first antennas and the second antennas; a setting unit configured to set, based on the channel response values, a plurality of MIMO parameters; and a transmission unit configured to perform multicast transmission to each of the radio communication terminals via the second antennas, based on the MIMO parameters, the multicast transmission being performed based on a multiple-input multiple-output (MIMO) transmission scheme, each of the radio communication terminals further including a receiving unit which receives data transmitted from the radio communication apparatus by the multicast transmission.

In accordance with another embodiment, there is provided a radio communication system comprising: a plurality of first antennas included in each of a plurality of radio communication terminals; a plurality of second antennas used for performing multicast transmission to the radio communication terminals, respectively, the multicast transmission being performed based on a multiple-input multiple-output (MIMO) transmission scheme; an acquisition unit configured to acquire a plurality of channel response values between the first antenna and the second antennas; a setting unit configured to set, based on the channel response values, a plurality of MIMO parameters; and a transmission unit configured to perform multicast transmission to each of the radio communication terminals via the second antennas, respectively, based on the MIMO parameters.

In accordance with yet another embodiment of the invention, there is provided a radio communication method comprising: preparing a plurality of first antennas included in each of a plurality of radio communication terminals; preparing a plurality of second antennas used for performing multicast transmission to the radio communication terminals, the multicast transmission being performed based on a multiple-input multiple-output (MIMO) transmission scheme; acquiring a plurality of channel response values between the first antennas and the second antennas; setting, based on the channel response values, a plurality of MIMO parameters; and performing multicast transmission to each of the radio communication terminals via the second antennas, based on the MIMO parameters.

### BRIEF DESCRIPTION OF THE SEVERAL VIEWS OF THE DRAWING

FIG. 1 is a view illustrating the concept of the MIMO transmission;

FIG. 2 is a view illustrating MIMO channels expressed using equivalent virtual channels;

FIG. 3 is a view illustrating a radio communication system according to the embodiment using multicast transmission based on MIMO;

FIG. 4 is a view illustrating the states of channels assumed in the case of FIG. 3;

FIG. 5 is a block diagram illustrating a radio communication system according to a first embodiment of the invention;

FIG. 6 is a flowchart illustrating the operation of the radio communication system of FIG. 5;

FIG. 7 is a table showing combinations of the antennas of two radio communication apparatuses, and the S/N of each radio communication terminal;

FIG. 8 is a block diagram illustrating a radio communication system according to a third embodiment of the invention;

FIG. 9 is a block diagram illustrating a radio communication system according to a fourth embodiment of the invention; and

FIG. 10 is a block diagram illustrating an example of a radio communication system employing the number of antennas in a receiving side for receiving signals.

### DETAILED DESCRIPTION OF THE INVENTION

Radio communication apparatuses each having a plurality of antennas, radio communication systems and radio communication methods according to embodiments of the invention will be described in detail with reference to the accompanying drawings.

The embodiments of the present invention has been developed in light of the above, and aims to provide a radio communication apparatus with a plurality of antennas, and a radio communication system, which enable a plurality of radio communication terminals to achieve satisfactory characteristics, when performing multicasting based on MIMO transmission, and a radio communication method employed therein.

Radio communication apparatuses each having a plurality of antennas, radio communication systems and radio communication methods according to embodiments of the invention enable radio communication terminals to exhibit excellent characteristics, when performing multicast transmission in which the same signal is simultaneously transmitted to a plurality of radio communication terminals, utilizing MIMO transmission.

In the embodiments of the invention, when a radio communication apparatus (access point: hereinafter referred to as “AP”) performs multicast transmission on a plurality of radio communication terminals (hereinafter referred to as “STAs”), utilizing MIMO transmission, the MIMO channel characteristic (channel response) between the AP and each STA is fed back to set, based on a predetermined criterion, a MIMO parameter that enables the STAs to exhibit as good characteristics as possible. The MIMO parameters may be, for example, the respective numbers assigned to the transmission antennas, the number of the transmission antennas, the respective numbers assigned to the transmission beams, the number of the transmission beams, or the shape patterns of the transmission beams.

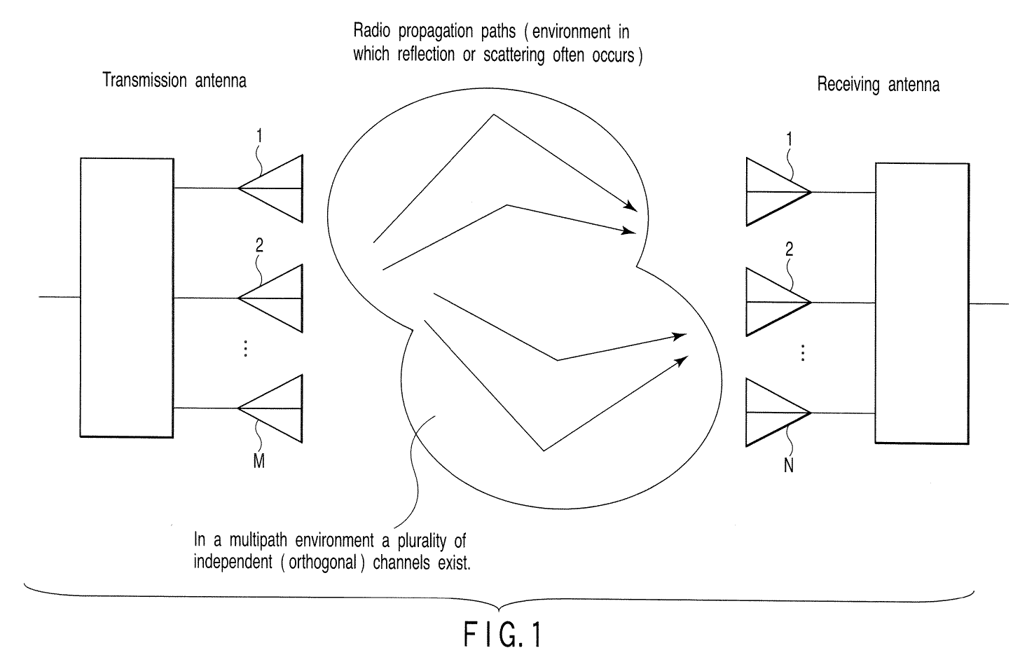

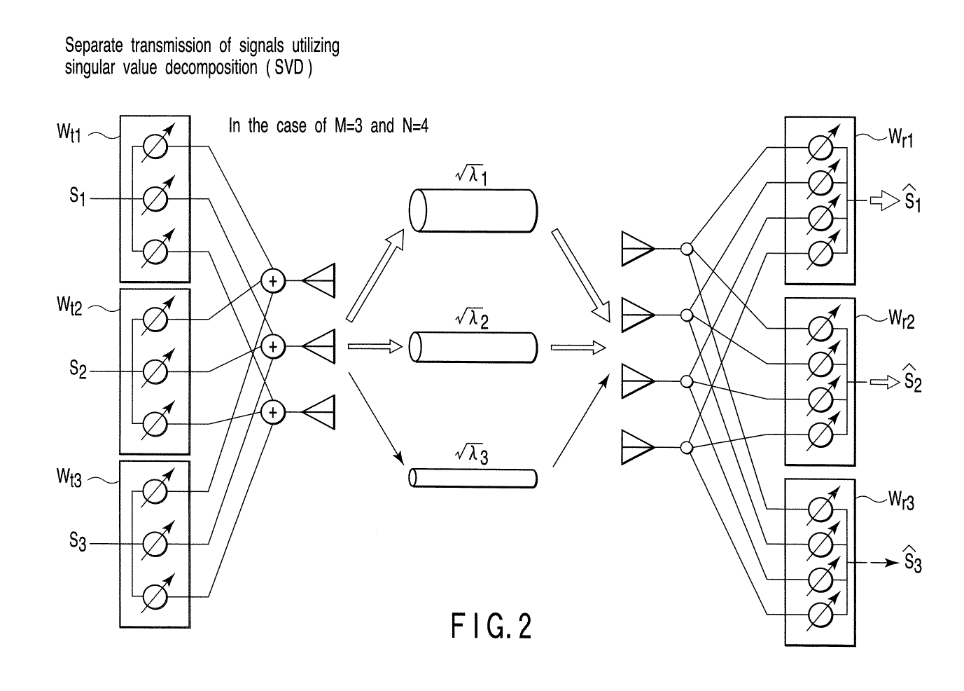

Referring first to FIGS. 1 and 2, the concept of the MIMO transmission scheme will be described. It is assumed that the radio communication apparatuses and radio communication terminals perform one-to-one communication.

In general, indoor radio communication is performed in a multipath/fading environment in which a large number of reflected waves or scattering waves exist. In this case, a plurality of independent channels that do not interfere each other (also called spatially orthogonal channels) may exist between two radio machines communicating with each other. The number of independent channels that do not interfere each other is called the number of paralleled paths. In MIMO, independent channels are detected, and different signals are transmitted through these channels in a parallel manner, thereby realizing high-speed transmission. To recognize the individual channels, it is necessary to employ a plurality of antennas for transmission and reception. For instance, the transmission side is provided with M antennas and the receiving side is provided with N antennas, as shown in FIG. 1.

In light of the degree of freedom of the antennas, K (K is the smaller one of M and N) independent channels can be detected theoretically. In, for example, singular value decomposition (SVD) as one of the MIMO transmission schemes, to detect independent channels, the channel response values between the antennas are detected (measured), and the channel response matrix computed from the channel response values is subjected to eigenvalue decomposition.

Moreover, if beams are formed for transmission and reception based on the eigenvectors acquired by the computation, efficient MIMO transmission can be executed. As a result, such virtual channels as shown in FIG. 2 could be utilized. In FIG. 2, the transmission side employs three antennas, and the receiving side employs four antennas. In this case, for transmission and reception of S1 using the channel corresponding to eigenvalue λ₁, the transmission side uses transmission beam 1 formed using weight wₜ₁, and the receiving side uses reception beam 1 formed using weight wᵣ₁. Similar transmission and reception is performed concerning λ₂ and λ₃, thereby performing parallel transmission of different signals.

The example shown in FIGS. 1 and 2 is directed to one-to-one communication based on MIMO between the radio communication apparatuses and radio communication terminals. The channel response to be acquired depends upon, for example, the positional relationship between the corresponding radio communication apparatus and radio communication terminal. Further, the orthogonal channel and optimal transmission/reception antenna weight resulting from the channel response depend upon such an electromagnetic wave propagation environment as the positional relationship between the corresponding radio communication apparatus and radio communication terminal.

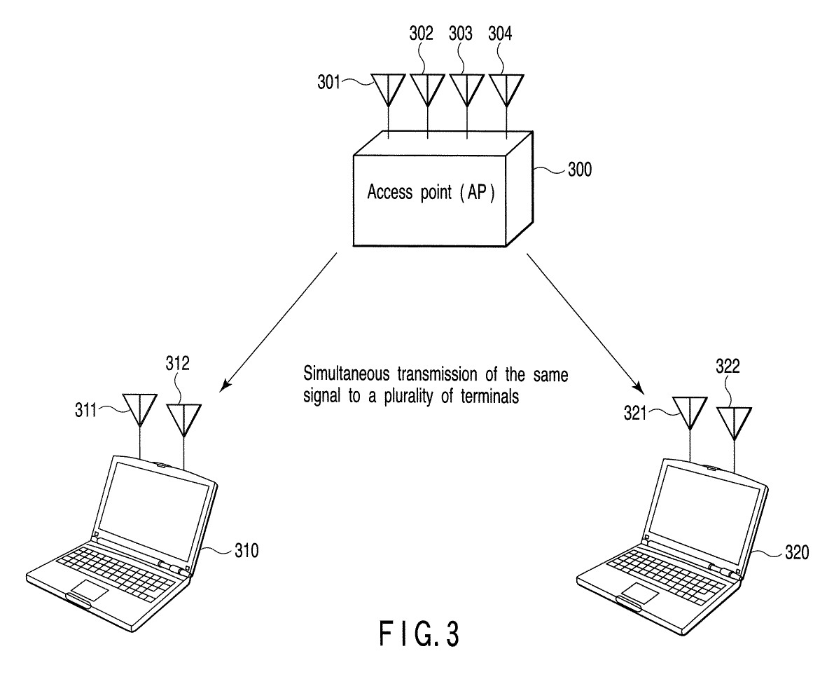

Problems may occur in the case of multicast transmission in which the same signal is simultaneously transmitted to a plurality of radio communication terminals, using MIMO. For instance, when radio systems using MIMO become spread, a request to simultaneously distribute the same information to a plurality of radio communication terminals (STAs) as shown in FIG. 3 may be issued. However, the MIMO parameter, such as transmission/reception weights, determined by the conventional scheme is optimized under the condition of one-to-one transmission between radio communication apparatuses and terminals. Therefore, in the situation shown in FIG. 3, when the receiving state of one radio communication terminal is optimal, that of the other terminal may not be appropriate. Namely, satisfactory multicast transmission may not be realized.

(Ways of Use)

Referring to FIG. 3, a description will be given of the ways of use of the radio communication apparatus with antennas, the radio communication system and the radio communication method.

The radio communication apparatus (access point AP) 300 includes four antennas 301, 302, 303 and 304. Radio communication terminal (STA A) A 310 includes two antennas 311 and 312, and radio communication terminal (STA B) B 320 includes two antennas 321 and 322. Assume here that (2×2) MIMO transmission processes are executed between the AP and STAs (each of the transmission and receiving sides has two antennas, and parallel transmission is executed using two channels). The AP is characterized in that the number of antennas thereof is greater than that of channels used for MIMO transmission.

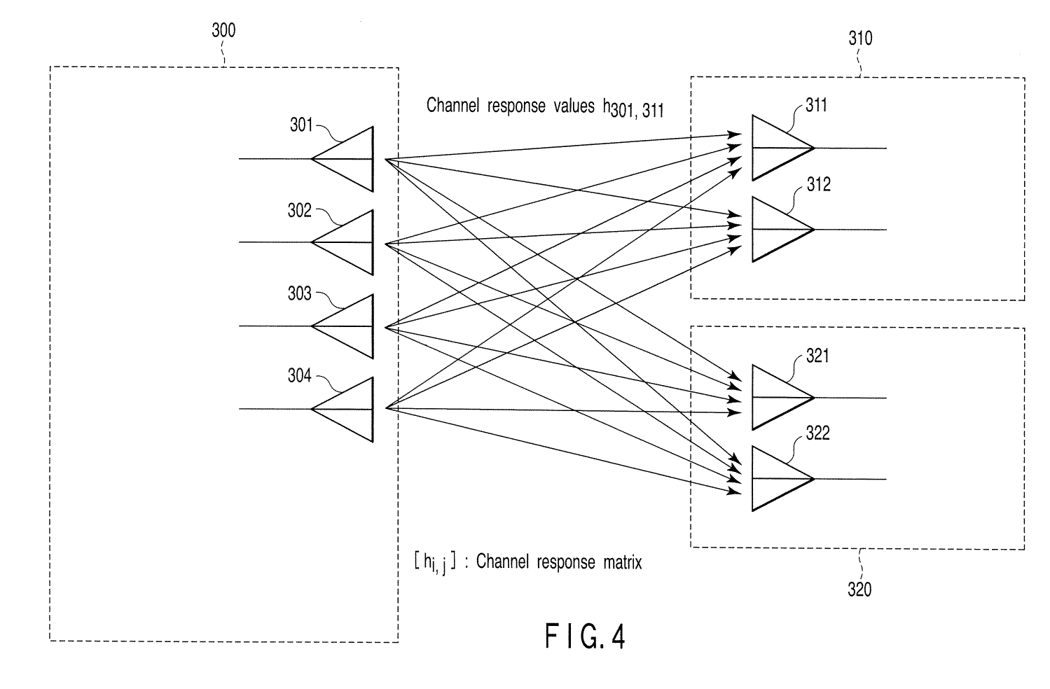

Referring now to FIG. 4, the states of the channels in the above case will be described. Assume here that the channel response between transmission antenna i of the AP and receiving antenna j of the STAs is h_{i,j}. For instance, the channel response between the transmission antenna 301 of the AP and the receiving antenna 311 of the STAs is h_{301, 311}. The channel response is the propagation characteristic between corresponding transmission and receiving antennas in the multipath/fading environment.

### First Embodiment

### CONFIGURATION EXAMPLE

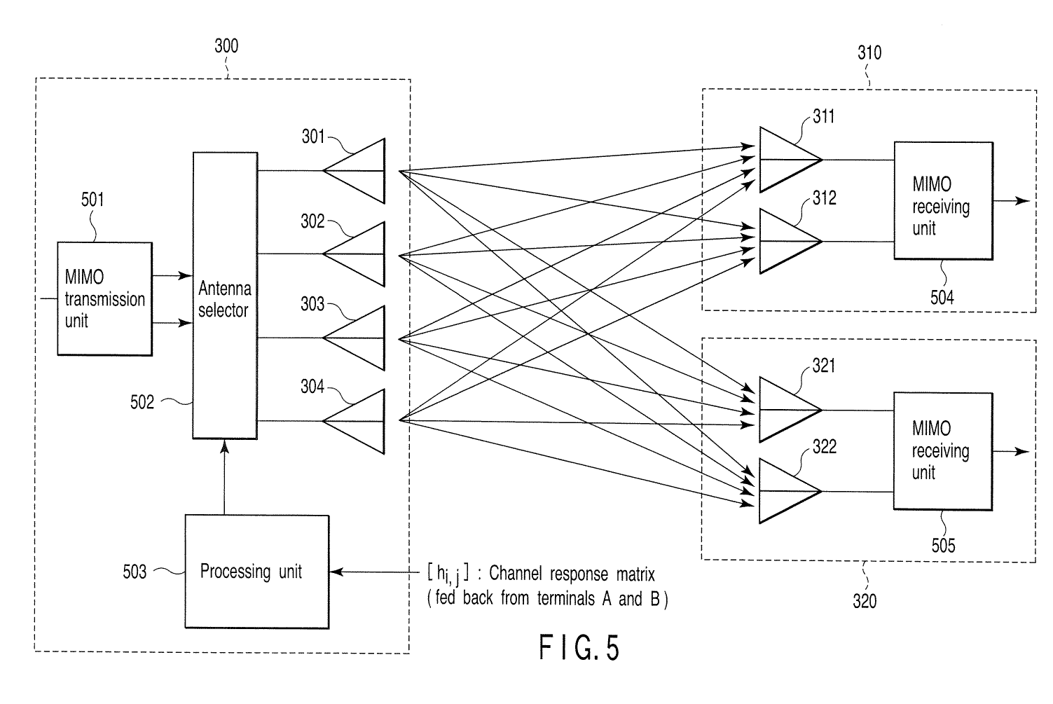

Referring to FIG. 5, a description will be given of a radio communication apparatus (access point, AP) with a plurality of antennas, and radio communication terminals (STAs).

In FIG. 5, an access point 300 has four antennas 301, 302, 303 and 304, MIMO transmitter 501, antenna selector 502 and processing unit 503. Assume that only two of the antennas 301 to 304 are actually used.

The MIMO transmitter 501 generates transmission signals corresponding to two streams (two paths) for performing (2×2) MIMO transmission processes.

The antenna selector 502 selects two from the four antennas, and sends the transmission signals to the selected antennas. The transmission signals are then emitted as electromagnetic waves from the antennas.

Before the AP performs MIMO transmission, the two antennas of each STA feed back, to the processing unit 503 of the AP, the channel response values h_{i,j} supplied from the four antennas of the AP. Based on the channel response values h_{i,j}, the processing unit 503 selects two optimal antennas for transmission from the four antennas.

No detailed description is not given of the means (hardware means) for feeding back the channel response h_{i,j} from each STA to the AP. Any transmitter or receiver, which performs communication by radio, can be used as the means. Depending on the circumstances, a different radio communication system, optical transmission system or cable communication system can also be utilized.

Further, the means for feeding back the channel response h_{i,j} from each STA to the AP is not always needed. For instance, in the case of a system for transmitting and receiving signals in a time-division manner using the same frequency, the channel response for the AP is identical between transmission and reception. Accordingly, if the AP estimates the channel response based on a communication signal or pilot signal supplied from each STA before transmitting data to each STA, and stores it, such feedback control as the above is not necessary.

The radio communication terminal A 310 has the antennas 311 and 312 and MIMO receiver 504, while the radio communication terminal B 320 has the antennas 321 and 322 and MIMO receiver 505.

The antennas 311, 312, 321 and 322 receive electromagnetic waves emitted from the AP. Each of the MIMO receivers 504 and 505 demodulates the signal received by the two antennas of the corresponding STA.

(Control Method)

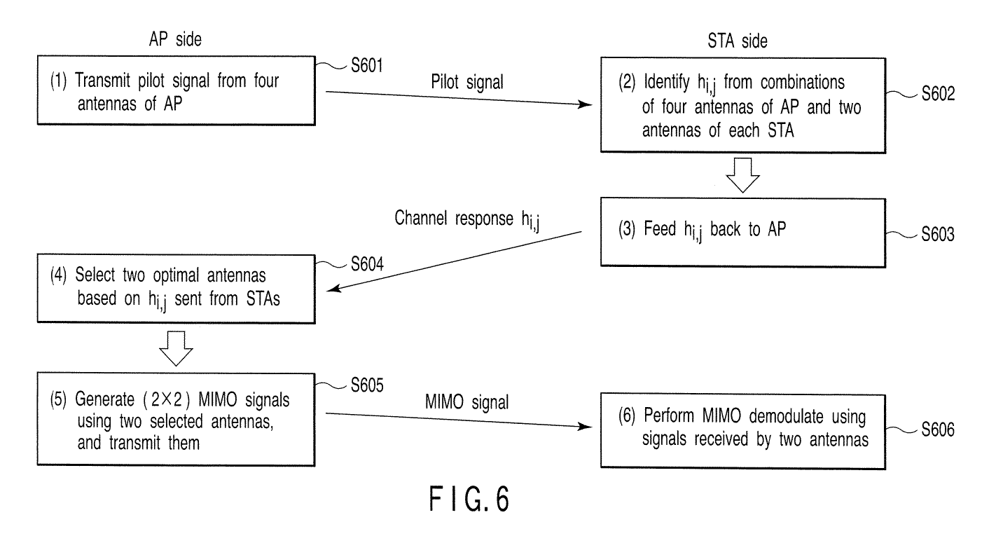

Referring to FIG. 6, a description will be given of the operation of the radio communication system according to the first embodiment. FIG. 6 is a flowchart useful in explaining the transmission and control of signals between the AP and the STAs.

The access point (AP) 300 transmits, through the four antennas 301 to 304 to the STAs, a pilot signal used by them for estimating the channel response values h_{i,j} (step S601). In this case, 16 channel response values (4 (the antennas of the AP)×4 (the entire antennas of the two STAs)) are necessary. Further, the pilot signal may be sequentially transmitted to the transmission antennas, or be transmitted along with orthogonal codes superposed thereon. Alternatively, the access point may perform estimation based on a signal used during ordinary communication processing, instead of generating a particular pilot signal (i.e., when no MIMO transmission processing is performed).

Upon receiving the pilot signal from the AP, the two STAs, i.e., the radio communication terminals A 310 and B 320, estimate the channel response values h_{i,j} (step S602).

The radio communication terminals A 310 and B 320 feed back h_{i,j} to the AP (step S603). When data is transmitted from the two STAs to the AP, it is necessary to avoid interference. Without interference, transmission may be performed in a time-division manner or utilizing multiplexing based on orthogonal coding.

In the access point 300, the processing unit 503 selects two optimal antennas for transmission from the antennas 301 to 304, based on h_{i,j} supplied from the STAs (step S604). As will be described later, the processing unit 503 of the access point 300 selects two antennas that can optimize the transmission rate for the two STAs. More specifically, the processing unit 503 selects two antennas that can transmit the maximum power to the two STAs, or can transmit data to the two STAs with the maximum signal-to-noise (S/N) ratio.

In the access point 300, the antenna selector 502 generates (2×2) MIMO transmission signals based on the information indicating the antennas selected by the processing unit 503, whereby the MIMO transmission signals are transmitted from the selected antennas (step S605). The scheme for MIMO transmission is not limited to any particular one. It may be space time coding (STC) as transmission diversity, or space division multiplexing (SDM). Of course, weighted SDM, in which the transmission antennas are weighted by SDM, or eigenbeam SDM set by subjecting a channel response matrix to eigenvalue expansion may be utilized. Thus, the MIMO transmission signals are transmitted to each STA by multicasting, using the two antennas.

The radio communication terminal A 310 performs MIMO demodulation on the signals received by the two antennas, using the MIMO receiver 504, and the radio communication terminal B 320 performs MIMO demodulation on the signals received by the two antennas, using the MIMO receiver 505 (step S606). The demodulation scheme is varied in accordance with the MIMO transmission scheme. For instance, in the case of STC, particular time-space decoding is utilized. In the case of SDM, space filtering, sequencing decoding, parallel interference canceller or maximum likelihood detection (MLD), etc. is utilized.

Among the above-described steps, step S604 is the most important one, i.e., it is most important to select two antennas that can provide the two STAs with the optimal transmission rate or MIMO channel capacitance, and to perform MIMO transmission. By virtue of this step, efficient multicast transmission is realized.

(Criteria of Judgment)

A description will now be given of the criteria of judgment used by the processing unit 503 to select optimal antennas for transmission. The following criteria could be utilized:

(1) Maximizing the minimum transmission rate for the two STAs;

(2) Maximizing the average transmission rate for the two STAs;

(3) Maximizing the minimum MIMO channel capacitance for the two STAs;

(4) Maximizing the average MIMO channel capacitance for the two STAs;

(5) Minimizing the highest bit error rate (BER) or packet error rate (PER) acquired when data is transmitted to the two STAs; or

(6) Minimizing the sum of bit error rates (BER) or packet error rates (PER) acquired when data is transmitted to the two STAs.

Specific antenna selection methods based on the above criteria will be described.

<Methods for Maximizing Transmission Rate> (This relates to above items (1) and (2))

To maximize the transmission rates for the two STAS, the following specific methods are conceivable:

(a) Channels of high S/N ratios are selected. Namely, channels of high channel response levels (power levels) are selected.

(b) Substantially orthogonal channels are selected. Namely, a combination of channels that have channel response values of a low correlation is selected.

(c) Methods (a) and (b) are combined. In light of the results of (a) and (b), an evaluation function acquired by appropriately weighting the results of (a) and (b) is defined, and judgment is performed based on the evaluation function.

Evaluation functions are defined based on methods (a), (b) and (c), and the antennas that maximize the transmission rates are selected. To this end, the following specific methods, for example, could be utilized.

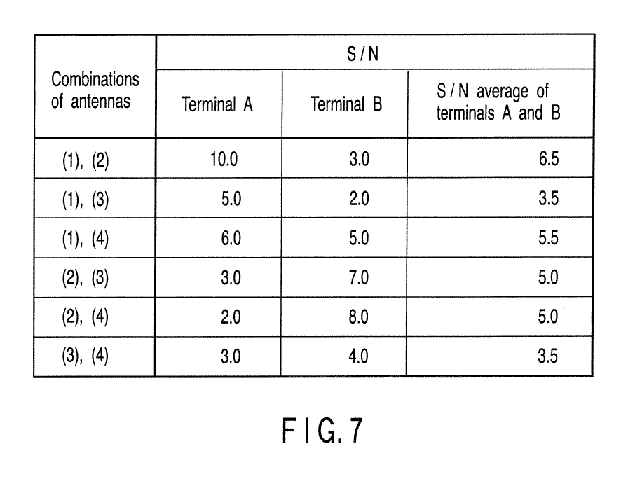

Assume here that, for example, the S/N is regarded as an evaluation function. To maximize the minimum transmission rate for the two STAs (the lower one of the two rates for the two STAs) (i.e., in the case of item (1)), when data is received by the two antennas of each of the two STAs, a combination of transmission antennas, which provides the highest one of the minimum S/N values as the evaluation function, is selected from six combinations of transmission antennas that are acquired by selecting two from the four transmission antennas of the AP. FIG. 7 shows the combinations of antennas and the S/N values acquired in the STAs. In the examples of FIG. 7, the minimum value of the S/N values acquired from the two STAs using the combination of transmission antennas 1 and 2 is 3.0. Similarly, the minimum value of the S/N values acquired from the two STAs using the combination of transmission antennas 1 and 3 is 2.0. The minimum value of the S/N values acquired from the two STAs using the combination of transmission antennas 1 and 4 is 5.0. The minimum value of the S/N values acquired from the two STAs using the combination of transmission antennas 2 and 3 is 3.0. The minimum value of the S/N values acquired from the two STAs using the combination of transmission antennas 2 and 4 is 2.0. The minimum value of the S/N values acquired from the two STAs using the combination of transmission antennas 3 and 4 is 3.0. Thus, the highest one of the minimum values is acquired from the combination of antennas 1 and 4, therefore this combination is set as the optimal MIMO parameter (in this case, transmission antenna numbers).

To maximize the average transmission rate for the two STAs (i.e., in the case of item (2)), when data is received by the two antennas of each of the two STAs, a combination of transmission antennas, which provides the highest one of the average values of the evaluation functions concerning the eight channels formed by the two transmission antennas and four reception antennas, is selected from six combinations of transmission antennas that are acquired by selecting two from the four transmission antennas of the AP. In the examples of FIG. 7, the average value of the S/N values acquired from the two STAs using the combination of transmission antennas 1 and 2 is 6.5. Similarly, the average value of the S/N values acquired from the two STAs using the combination of transmission antennas 1 and 3 is 3.5. The average value of the S/N values acquired from the two STAs using the combination of transmission antennas 1 and 4 is 5.5. The average value of the S/N values acquired from the two STAs using the combination of transmission antennas 2 and 3 is 5.0. The average value of the S/N values acquired from the two STAs using the combination of transmission antennas 2 and 4 is 5.0. The average value of the S/N values acquired from the two STAs using the combination of transmission antennas 3 and 4 is 3.5. Thus, the highest one of the average values is acquired from the combination of antennas 1 and 2, therefore this combination is set as the optimal MIMO parameter (in this case, transmission antenna numbers). Although in the examples of FIG. 7, the S/N value is selected as the evaluation function, the channel response correlation value may be employed instead of the S/N value, or the combination of the S/N value and the channel response correlation value may be employed as the evaluation function.

<Methods for Maximizing Channel Capacitance> (This relates to above items (3) and (4)) Methods for maximizing the channel capacitance of each channel for the two STAs will be described.

The channel capacitance of each MIMO channel is acquired from the correlation matrix of channel response vectors (see, for example, A. Paulraj, R. Nabar and D. Gore, Introduction to Space-Time Wireless Communications, Cambridge University Press, Cambridge 2003, expressions (4.9) and (4.10) on page 65, and expression (4.19) on page 68). Accordingly, it is sufficient if the correlation matrix that maximizes the channel capacitance is selected. To this end, the following two methods, for example, can be utilized.

To maximize the minimum value of the MIMO channel capacitances for the two STAs (i.e., in the case of item (3)), when data is received by the two antennas of each of the two STAs, a combination of transmission antennas, which provides the highest one of the minimum channel capacitances for the two STAs computed from the correlation matrix corresponding to the two STAs, is selected from six combinations of transmission antennas that are acquired by selecting two from the four transmission antennas of the AP.

To maximize the average value of the MIMO channel capacitances for the two STAs (i.e., in the case of item (4)), when data is received by the two antennas of each of the two STAs, a combination of transmission antennas, which provides the highest one of the average channel capacitances for the two STAs computed from the correlation matrix corresponding to the two STAs, is selected from six combinations of transmission antennas that are acquired by selecting two from the four transmission antennas of the AP.

<Methods for Minimizing BER or PER> (This relates to above items (5) and (6))

To minimize the bit error rate (BER) or packet error rate (PER) related to the two STAs, the following methods could be utilized:

(A) Causing the AP to actually transmit a training signal to the STAs, and causing the STAs to measure BER or PER and use the measurement result as the evaluation function;

(B) Causing the AP or a dedicated apparatus other than the AP to perform simulation based on the channel response and use the resultant BER or PER as the evaluation function; or

(C) Computing the signal power to interference plus noise power ratio (SINR) of each STA based on the channel response, and estimating the error rate of each STA using an error complementary function.

Using each of the thus-acquired evaluation functions, the following methods, for example, could be utilized.

To minimize the highest BER or PER acquired when data is transmitted to the two STAs (i.e., in the case of item (5)), a combination of transmission antennas, which provides the lowest one of the maximum values of the two evaluation functions concerning BER or PER and acquired for each STA when data is MIMO-transmitted to the two STAs, is selected from six combinations of transmission antennas that are obtained by selecting two from the four transmission antennas of the AP.

To minimize the sum of BERs or PERs acquired when data is transmitted to the two STAs (i.e., in the case of item (6)), a combination of transmission antennas, which minimizes the sum of BERs or PERs acquired for STA, is selected from the six combinations of transmission antennas.

The above-described configuration, control method and criteria of judgment, employed in the first embodiment, can provide the following advantages:

(1) When simultaneously accessing particular STAs by multicasting, the STAs as a whole can realize efficient high-speed transmission. This means that the situation can be avoided, in which one of the STAs realizes high-speed transmission, and the other realizes only low-speed transmission, to which no multimedia services can be provided. Namely, all STAs can enjoy satisfactory radio communication services.

(2) All STAs can perform transmission of a speed not lower than a preset value, and are free from the situation in which, for example, retransmission is repeated because an STA of a low speed exists, and therefore the whole STAs perform inefficient multicast radio transmission. This also enables all STAs to enjoy satisfactory radio services during multicasting.

In other words, even if the number of STAs to be subjected to multicast radio transmission is greater than in the prior art, they can enjoy satisfactory radio services. Thus, the first embodiment is advantageous in increasing the number of STAs subjected to multicasting.

In addition, since data is transmitted by radio to a greater number of STAs using the same channel, the efficiency of use of the frequency source can be enhanced accordingly.

Note that the same advantage as the above can be acquired if the first embodiment is modified as follows.

In the embodiment, it is determined which ones of the transmission antennas are selected as MIMO transmission parameters for optimizing multicast transmission (i.e., numbers assigned to optimal transmission antennas are set as parameters). However, even if other MIMO parameters are used for optimization, the same advantage can be acquired. Other parameters include the number of the transmission antennas, numbers assigned to transmission beams, the number of the transmission beams, the shape patterns of the transmission beams, the modulation scheme of each antenna or beam, or transmission power, etc. Other parameters will now be described.

### Second Embodiment

In the first embodiment, two antennas serving as the transmission antennas of the AP are selected from four antennas. However, the number of all antennas and the number of antennas selected therefrom may be changed. Further, the number of selected antennas may be optimized. In this case, the number of transmission antennas (i.e., the antennas of the AP) may be equal to that of receiving antennas (i.e., the antennas of the STA). Alternatively, the number of transmission or receiving antennas may be set greater than the number of paralleled paths in the MIMO scheme to expect the diversity effect.

As a method for optimizing the number of antennas, the following method could be utilized.

Based on the above-described criteria of judgment (such as the transmission rate, channel capacitance, BER and PER), the number of antennas is optimized. Resulting from the optimization of the number of antennas, higher speed, more satisfactory multicast radio transmission can be realized.

In the above case, in general, the larger the number of antennas, the better the transmission characteristic. In light of this, the number of antennas is optimized based on an appropriate evaluation function. The appropriate evaluation function is defined by considering negative factors, such as the power consumption and required processing time, which occur when the number of antennas to be operated is increased, and by weighting the degree of enhancement in transmission rate characteristic with the degree of degradation therein due to the negative factors. This method enables efficient high-speed transmission with the power consumption and required processing time suppressed.

### Third Embodiment

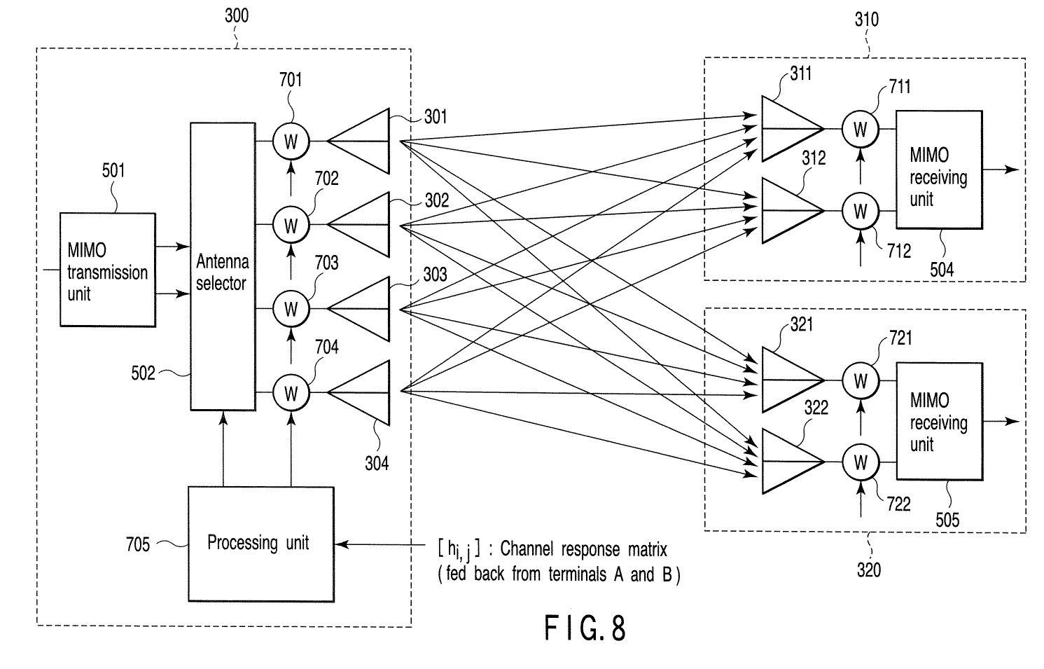

Referring to FIG. 8, a description will be given of a radio communication apparatus (access point, AP) and radio communication terminals (STAs) with a plurality of antennas, according to a third embodiment. In the following description, elements similar to the above-described ones are denoted by corresponding reference numbers, and no detailed description is given thereof.

The third embodiment differs from the first embodiment in that in the former, the antennas of the AP and STAs are weighted, i.e., the former employs means for setting a preset amplitude and phase for each of the transmission and reception signals.

As shown in FIG. 8, weighting units 701, 702, 703 and 704 perform weighting on the transmission signals transmitted from antennas 301, 302, 303 and 304, respectively, based on instructions from a processing unit 705.

The processing unit 705 performs, as well as processes similar to those of the processing unit 503, weighting control based on the channel response values h_{i,j} transmitted from the four antennas of the AP and received by the two antennas of each STA. By performing weighting on the transmission antennas, transmission diversity, transmission beam forming and space-division multiplexing can be performed, thereby increasing the gains of transmission signals and/or suppressing unnecessary radiation. Similarly, if weighting is performed on the receiving antennas, reception diversity, reception beam forming (including null forming for path separation) and separation of spatially multiplexed waves, etc. are performed, thereby enhancing the quality of received signals or suppression of unnecessary interference waves.

Similarly, weighting units 711, 712, 721 and 722 for weighting received signals are provided for the antennas 311, 312, 321 and 322 of the STAs, respectively. The weighting units 711, 712, 721 and 722 are controlled by controllers (not shown) installed in the respective STAs.

These weighting units can be easily realized by digital circuits if the signals are digital baseband signals. If the signals are analog signals, the weighting units can be easily realized by variable-gain amplifiers or phase shifters.

The antenna selector 502 has the function of selecting necessary ones of the transmission antennas. Alternatively, all antennas may be used without using the antenna selector 502.

The direction and shape of a transmission beam can be optimized by adjusting the weight coefficient of each transmission antenna. To optimize a beam, the following methods could be utilized:

(1) The AP generates a beam that covers the two STAs. This enables the two STAs to have excellent S/N and communication equality. Further, this enables an STA located at a farther place to be covered, which means that multicast transmission can be performed on STAs distributed in a wide area.

(2) The AP generates transmission beams that reduce the correlation coefficient of the signals received by the antennas of the two STAs or by the beams generated by the STAs. This enhances the orthogonality of the MIMO channels, thereby realizing transmission of information at a higher transmission rate.

### Fourth Embodiment

A fourth embodiment is characterized in that weighting is performed on both the transmission and receiving antennas to perform optimization so as to make the channels corresponding to the two STAs be orthogonal to each other. This method is similar in principle to so-called singular value decomposition (SVD), in which when one-to-one MIMO transmission is performed, the channel matrix based on the channel response is subjected to eigenvalue expansion to thereby form an intrinsic beam for MIMO transmission. However, since a plurality of receiving terminals exist, it is generally difficult to detect, for the receiving terminals, channels that are simultaneously and strictly orthogonal to each other. Therefore, the weighting coefficients assigned to the transmission and receiving antennas are optimized so as to form, for the receiving terminals, channels that are substantially orthogonal to each other. In the fourth embodiment, MIMO transmission is performed using, for example, two antennas at the transmission side and two antennas at the receiving side,

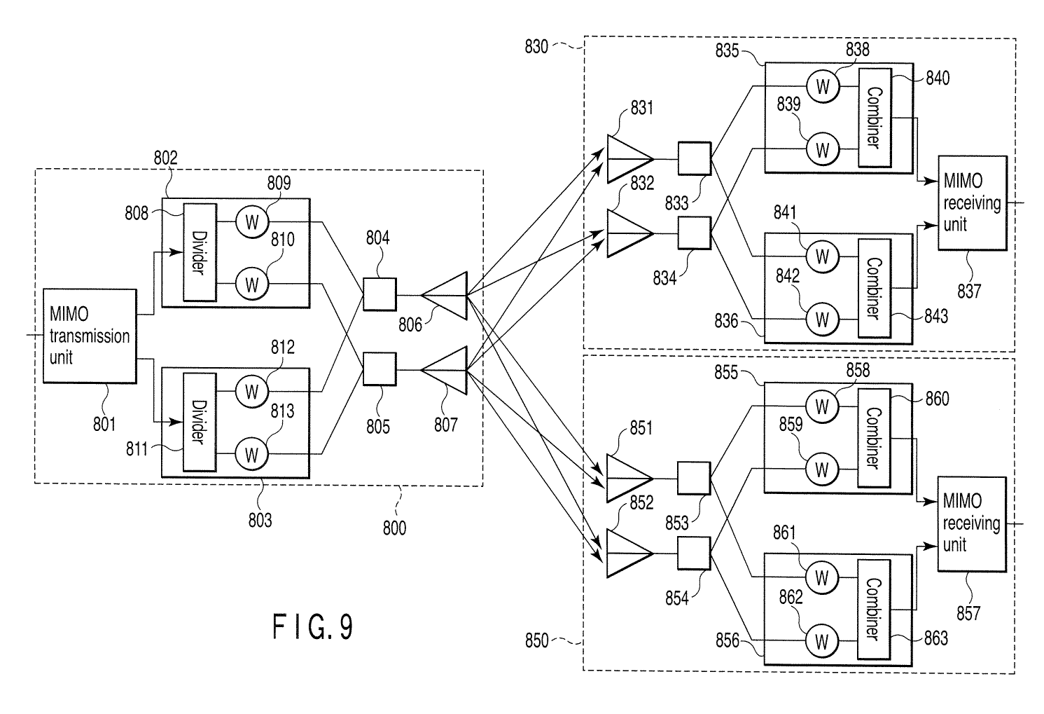

Referring to FIG. 9, a description will be given of a radio communication apparatus (access point, AP) 800 and radio communication terminals (STAs) with a plurality of antennas, according to the fourth embodiment.

The access point (AP) 800 comprises a MIMO transmission unit 801, beam forming units 802 and 803, combiners 804 and 805 and transmission antennas 806 and 807. The beam forming unit 802 includes a divider 808 and weighting unit 809 and 810. The beam forming unit 803 includes a divider 811 and weighting unit 812 and 813.

The MIMO transmission unit 801 generates two signal streams as transmission signals for MIMO transmission, and inputs the respective streams to the beam forming units 802 and 803.

In the beam forming unit 802, the divider 808 distributes the input stream into the weighting units 809 and 810, where the streams are weighted. In the beam forming unit 803, the divider 811 distributes the input stream into the weighting units 812 and 813, where the streams are weighted. Further, as in the first embodiment, a processing unit (not shown) informs the weighting units 809, 810, 812 and 813 of respective degrees of weighting. As will be described later, the processing unit optimizes weight coefficients and outputs them to the weighting units 809, 810, 812 and 813.

The combiner 804 synthesizes the weighted signals output from the weighting units 809 and 812. The synthesized signal is transmitted through the antenna 806. The combiner 805 synthesizes the weighted signals output from the weighting units 810 and 813. The synthesized signal is transmitted through the antenna 807. Since the same two antennas are used by each of the beam forming units 802 and 803, the two signal streams for MIMO transmission are synthesized in units of antennas by each of the combiners 804 and 805.

A radio communication terminal A 830 comprises antennas 831 and 832, dividers 833 and 834, beam forming units 835 and 836 and MIMO receiver 837. The beam forming unit 835 includes weighting units 838 and 839 and combiner 840, and the beam forming unit 836 includes weighting units 841 and 842 and combiner 843. A radio communication terminal B 850 has the same structure as the radio communication terminal A 830. The two radio communication terminals (STAs) A 830 and B 850 receive MIMO signals. In this embodiment, only the STA A 830 will be described.

The antennas 831 and 832 receive signals generated by the AP, and the dividers 833 and 834 distribute, into the beam forming units 835 and 836, the signals received by the antennas 831 and 832. In the beam forming unit 835, the two weighting units 838 and 839 weights the signals received by the two antennas, and the combiner 840 synthesizes the weighted signals. The MIMO receiver 837 receives the signals output from the combiners 840 and 843, and demodulates them into the transmission signal. The radio communication terminal B 850 performs the same operation as the terminal A 830.

Further, a processing unit (not shown) informs the weighting units 838 and 839 of respective degrees of weighting. As will be described later, the processing unit optimizes weight coefficients and outputs them to the weighting units 838 and 839. This instruction may be issued to the weighting units by the radio communication apparatus via the processing unit of the radio communication terminal A 830.

The method of optimizing weight coefficients performed by the processing unit will be described.

As described above, if weighting is performed to form, for two radio communication terminals, channels that are not strictly but substantially orthogonal to each other, signals can be transmitted at a high rate to both terminals. This type of weighting can be realized by, for example, the following methods:

(1) The power levels of the receiving response values (receiving signals) of the channels acquired by the corresponding beams resulting from weighting performed by the corresponding transmission and receiving antennas are used as evaluation function values, and the average value or minimum value of the power levels is maximized. To acquire the weight coefficient that realizes the maximization, the least square method or steepest descent method, etc., can be utilized. As the initial value, the weighting coefficient may be utilized, which is acquired by optimization using SVD in one of the radio communication terminals.

(2) The correlation values of the receiving response values (receiving signals) of the channels acquired by the corresponding beams resulting from weighting performed by the corresponding transmission and receiving antennas are used as evaluation function values, and the average value or maximum value of all correlation values is minimized. To acquire the weight coefficient that realizes the minimization, the same method as that specified in item (1) can be utilized.

(3) An evaluation function is defined in light of both the power levels in item (1) and the correlation values in item (2), and the weight coefficient that optimizes this evaluation function is used.

In the above-described fourth embodiment, parallel MIMO transmission can be efficiently executed during multicast transmission in which the same signal is simultaneously transmitted to a plurality of radio communication terminals, whereby information can be transmitted at a higher transmission rate than in the prior art. Further, the fourth embodiment can realize a multicast service environment of extremely high transmission efficiency.

If the third or fourth embodiment is modified in the following manners, the same advantage as the above can be acquired.

(1) If the processing unit employs an optimal modulation scheme for each transmission antenna or each transmission beam, a transmission rate of the maximum efficiency can be realized. For instance, in the case of using a multi-value QAM modulation scheme, if the maximum multi-value that enables data to be transmitted with the communication quality maintained (i.e., at a level with no errors) is set for each channel, the highest transmission rate can be realized.

(2) If the processing unit optimizes the transmission power for each transmission antenna or each transmission beam, it can optimize the power efficiency. Namely, if the transmission power is set to the maximum effective isotropic radiated power level allowable in the Radio Law, a high transmission rate can be realized in a wider range, with the Radio Law complied with. This is advantageous in widening the service area of multicast radio transmission for radio communication terminals. In contrast, if a necessary minimum transmission power level is set for realizing a preset transmission rate, the power consumption of the AP can be reduced.

(3) Theoretically, as many orthogonal beams as the antennas can be formed. Accordingly, the number of orthogonal beams (including not only strictly orthogonal beams but also substantially orthogonal beams) can be freely set to a value falling within the range of 2 to a value equal to the number of antennas. If the number of beams is set to a necessary minimum value for the to-be-realized transmission rate, the power consumption and processing time can be reduced. In the third or fourth embodiment, such efficiency as the above can be realized by setting, to an optimal value, the number of orthogonal (substantially orthogonal) beams.

Even if each of the above-described embodiments is modified in the following manners, the above-described advantage can be acquired:

(1) Although the embodiments employ two radio communication terminals (STAs) for multicast transmission, the same advantage can be expected if a greater number of STAs than two are employed.

(2) The number of antennas and the number of parallel paths used in MIMO transmission are also not limited to the values employed in the embodiments.

(3) Although in the embodiments, the access point accesses each radio communication terminal, the same advantage as the above can be acquired even if each radio communication terminal accesses the access point. Of course, the access point and radio communication terminals can have both transmission and receiving antennas.

(4) The receiving side may employ a greater number of antennas than the number of parallel paths, and set, to an optimal value, the number of receiving antennas for receiving signals based on a preset criterion of judgment (or set numbers assigned to the receiving antennas). In this case, the characteristics (e.g., gain) of each radio communication terminal upon reception are enhanced, thereby enhancing the quality of data reception of each radio communication terminal, or widening the data receivable area of each radio communication terminal.

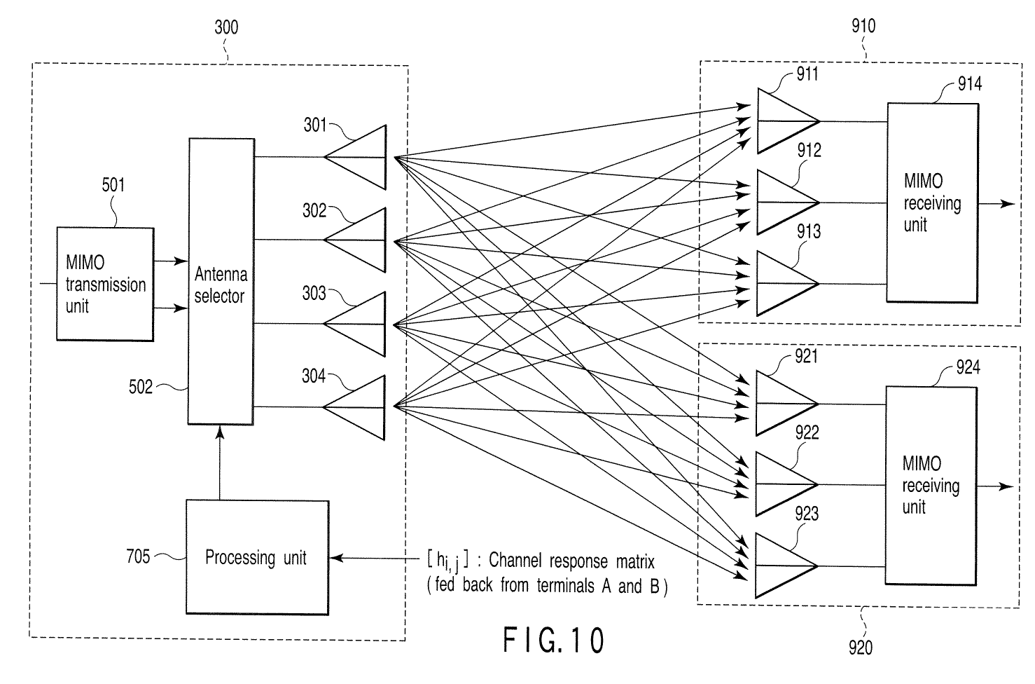

FIG. 10 shows an example of the radio communication system corresponding to the above. The access point 300 has the same configuration as that shown in FIG. 5. In this case, however, radio communication terminals A 910 and B 920 include antennas 911 to 913 and 921 to 923, respectively. Each radio communication terminal selects two antennas from the three antennas, whereby MIMO transmission is performed between the two antennas of the transmission side and the two antennas of the receiving side. Since the receiving-antenna selection means of each radio communication terminal is similar to the transmission-antenna selection means of the AP of the first embodiment, no description is given thereof.

The above-described embodiments can provide a radio communication apparatus with a plurality of antennas and a radio communication system capable of realizing such a satisfactory characteristic as a sufficiently high transmission rate, and a radio communication method employed therein. As a result, generally satisfactory communication (e.g., generally high-speed transmission) can be realized for a plurality of radio communication terminals.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio communication system comprising:
a plurality of radio communication terminals each of which includes a plurality of first antennas; and
a radio communication apparatus including:
a plurality of second antennas;
an acquisition unit configured to acquire a plurality of channel response values between the first antennas and the second antennas;
a setting unit configured to set, based on the channel response values, a plurality of MIMO parameters; and
a transmission unit configured to perform multicast transmission to each of the radio communication terminals via the second antennas, based on the MIMO parameters, the multicast transmission being performed based on a multiple-input multiple-output (MIMO) transmission scheme,
each of the radio communication terminals further including a receiving unit which receives data transmitted from the radio communication apparatus by the multicast transmission.

2. The system according to claim 1, wherein the MIMO parameters indicate configuration patterns of transmission beams formed by the radio communication apparatus and the radio communication terminals.

3. A radio communication system comprising:
a plurality of first antennas included in each of a plurality of radio communication terminals;
a plurality of second antennas used for performing multicast transmission to the radio communication terminals, respectively, the multicast transmission being performed based on a multiple-input multiple-output (MIMO) transmission scheme;
an acquisition unit configured to acquire a plurality of channel response values between the first antenna and the second antennas;
a setting unit configured to set, based on the channel response values, a plurality of MIMO parameters; and
a transmission unit configured to perform multicast transmission to each of the radio communication terminals via the second antennas, respectively, based on the MIMO parameters.

4. The system according to claim 3, wherein the setting unit sets the MIMO parameters to maximize one of a minimum value of transmission rates and an average of the transmission rates, the transmission rates representing transmission rates of signals transmitted from the radio communication apparatus to the radio communication terminals.

5. The system according to claim 3, wherein the setting unit sets the MIMO parameters to maximize one of a minimum value of channel capacitances and an average of the channel capacitances, the channel capacitances representing channel capacitances of signals transmitted from the radio communication apparatus to the radio communication terminals.

6. The system according to claim 3, wherein the setting unit sets the MIMO parameters to minimize a maximum value of transmission error rates of signals transmitted from the radio communication apparatus to the radio communication terminals.

7. The system according to claim 3, wherein the setting unit sets the MIMO parameters to minimize a sum of transmission error rates of signals transmitted from the radio communication apparatus to the radio communication terminals.

8. The system according to claim 3, wherein the MIMO parameters indicate configuration patterns of transmission beams formed by the radio communication apparatus and the radio communication terminals.

9. The system according to claim 3, wherein the MIMO parameters indicate number of the second antennas used for transmitting signals, respectively.

10. The system according to claim 3, wherein the MIMO parameters indicate numbers assigned to the second antennas used for transmitting signals, respectively.

11. The system according to claim 3, wherein the MIMO parameters indicate number of transmission beams formed by the radio communication apparatus.

12. The system according to claim 3, wherein the MIMO parameters indicate one of modulation schemes corresponding to configuration patterns of transmission beams formed by the radio communication apparatus, and modulation schemes for generating signals transmitted from the second antennas.

13. The system according to claim 3, wherein the MIMO parameters indicate one of transmission power levels corresponding to configuration patterns of transmission beams formed by the radio communication apparatus, and transmission power levels corresponding to transmitting signals from the second antennas.

14. A radio communication method comprising:
preparing a plurality of first antennas included in each of a plurality of radio communication terminals;
preparing a plurality of second antennas used for performing multicast transmission to the radio communication terminals, the multicast transmission being performed based on a multiple-input multiple-output (MIMO) transmission scheme;
acquiring a plurality of channel response values between the first antennas and the second antennas;
setting, based on the channel response values, a plurality of MIMO parameters; and
performing multicast transmission to each of the radio communication terminals via the second antennas, based on the MIMO parameters.
